(19) United States
(12) Patent Application Publication
(10) Pub. No.: US 2008/0314748 A1
(43) Pub. Date: Dec. 25, 2008

(54) GAS SENSOR

(75) Inventors: Masanobu Yamauchi, Kariya-shi (JP); Yasuyuki Sato, Kasugai-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/145,891

(22) Filed: Jun. 25, 2008

(30) Foreign Application Priority Data
Jun. 25, 2007 (JP) 2007-166098

(51) Int. Cl. G01N 27/26

(52) U.S. Cl. 204/431

(57) ABSTRACT

A gas sensor has a sensor element of a cup shape and an insulation electrical heater for heating the sensor element. The insulation electrical heater is placed in an inside of a hollow part of the sensor element. An insulation length extension area is formed on an outer peripheral surface of the insulation electrical heater between electrodes of the insulation electrical heater and a reference electrode metal member tightly bonded onto the sensor element. The insulation length extension area is composed of a plurality of flanges, a rectangle flange part formed in one body, a taper shaped flange part, or a bended flange part.

### CROSS-REFERENCE TO RELATED APPLICATION

This application is related to and claims priority from Japanese Patent Application No. 2007-166098 filed on Jun. 25, 2007, the contents of which are hereby incorporated by reference.

### BACKGROUND OF THE INVENTION

1. Field of the Invention

The present invention relates to a gas sensor equipped with a sensor element of a cup shape and an insulation electrical heater capable of heating the sensor element placed in the inside of a hollow part of the sensor element. The gas sensor is applicable to an oxygen concentration sensor to be mounted to an exhaust gas purifying apparatus for an internal combustion engine of a motor vehicle.

2. Description of the Related Art

There are various types of gas sensors. For example, Japanese patent laid open publication JP H10-10082 has disclosed a conventional gas sensor comprised of a sensor element of a cup shape and an insulation electrical heater. In this conventional gas sensor, the insulation electrical heater is capable of heating the sensor element. The insulation electrical heater is placed in the inside of a hollow part of the sensor element. In the conventional gas sensor, an outer peripheral surface of the insulation electrical heater made of ceramic (hereinafter, also referred to as the “ceramic heater”), which is positioned at an upper side observed from the end of the sensor element, has a vertical surface (or a flat surface). Further, a part or an area between electrodes of the ceramic heater and a reference electrode metal member has an approximately flat shape. The reference electrode metal member is bonded onto an inner peripheral surface of the sensor element.

A voltage is applied to the electrodes of the ceramic heater. The electrodes of the ceramic heater is made of materials such as silver, tin, and copper in order to be electrically connected to electric wires by brazing. Through the electric wires, an outer electric power is supplied to the electrodes of the ceramic heater.

Because dew condensation generated on the surface of the ceramic heater decreases the insulation characteristics between the electrodes and the reference electrode metal members, a part of the electric power applied to the ceramic heater leaks into the reference electrode metal members. The leakage phenomenon causes a possibility of causing a detection error of the gas sensor, so that the gas sensor outputs an error detection signal.

Under the presence of dew condensation or high humidity, ion migration phenomenon is easily generated between, where a direct current voltage is applied to the metal members. In particular, the ion migration phenomenon occurs between the electrodes of the ceramic heater and the reference voltage metal members in the gas sensor. This would cause electrode failure of the ceramic heater and deterioration of the insulation characteristics between the electrodes of the ceramic heater and the reference electrode metal members.

In general, the longer straight-line distance between the electrodes and the reference electrode metal members becomes, the more the insulation characteristics between the electrodes and the reference electrode metal members becomes superior. However, in order for this to happen the position of the electrodes or the reference electrode metal members need to shift closer to either the upper or lower side. Shifting the position of the electrodes or the reference electrode metal member further requires the positions of other components in the gas sensor to change. Thus, shifting the position of the electrodes or the reference electrode metal members toward either the upper or lower side in the gas sensor also extends the entire size of the gas sensor. The lengthening of the entire size of the gas sensor counters to a recent trend of miniaturization.

### SUMMARY OF THE INVENTION

It is an object of the present invention to provide a gas sensor with superior insulation characteristics and high reliability without lengthening or extending the entire size of the gas sensor. The gas sensor according to the present invention has an insulation length extension area which is formed between electrodes of an insulation electrical heater and a reference electrode metal member of a sensor element. The insulation length extension area is formed along the outer peripheral surface of the electrodes formed on the insulation electrical heater and the reference electrode metal member. This reference electrode metal member is bonded onto the sensor element. The formation of the insulation length extension area along the outer peripheral surface of the insulation electrical heater can substantially extend the distance between the electrodes and the reference electrode metal members.

To achieve the above purposes, the present invention provides a gas sensor having a sensor element of a cup shape, an insulation electrical heater configured to heat the sensor element, and an insulation length extension area. The insulation length extension area is formed along an outer peripheral surface of the insulation electrical heater between electrodes of the insulation electrical heater and a reference electrode metal member. The reference electrode metal member is bonded onto the sensor element. In particular, the effective insulation length along the surface of the insulation electrical heater measured from the electrodes to the reference electrode metal member is extended by the insulation length extension area.

Because the outer peripheral surface of the insulation electrical heater in a conventional gas sensor has a flat shape, the insulation characteristics are deteriorated when due condensation is generated on the outer peripheral surface of the insulation electrical heater.

On the contrary, the gas sensor according to the present invention has the insulation length extension area which is formed on the outer peripheral surface of the insulation electrical heater. The presence of the insulation length extension area drastically enhances the electrical insulation characteristics between the electrodes and the reference electrode metal member bonded onto the sensor element. Further, the above structure of the insulation electrical heater having the insulation length extension area avoids that the voltage at the electrodes affects the output voltage of the reference electrode metal member. This structure can increase the reliability of the gas sensor. Still further, this structure of the insulation electrical heater having the insulation length extension area can increase the effective insulation length along the surface measured from the electrodes and the reference electrode metal member of the sensor element without increasing the straight-line length between the electrodes and the reference electrode metal member. Therefore it is possible to have the above structure of the insulation electrical heater having the insulation length extension area without extending or lengthening the entire size of the gas sensor. That is, the gas sensor according to the present invention is almost same in entire size as the conventional gas sensor.

### BRIEF DESCRIPTION OF THE DRAWINGS

A preferred, non-limiting embodiment of the present invention will be described by way of example with reference to the accompanying drawings, in which:

FIG. 1 is a vertical cross section showing a gas sensor according to a first embodiment of the present invention;

FIG. 2 is an enlarged vertical cross section of a part of the gas sensor according to the first embodiment of the present invention;

FIG. 3 is an enlarged vertical cross section of a part of the gas sensor according to a second embodiment of the present invention;

FIG. 4 is an enlarged vertical cross section of a part of the gas sensor according to a third embodiment of the present invention;

FIG. 5 is an enlarged vertical cross section of a part of the gas sensor according to a fourth embodiment of the present invention; and

FIG. 6 shows experimental results of an output voltage of the gas sensor on changing the length between an electrode part and a reference electrode metal member including an insulation length extension area.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

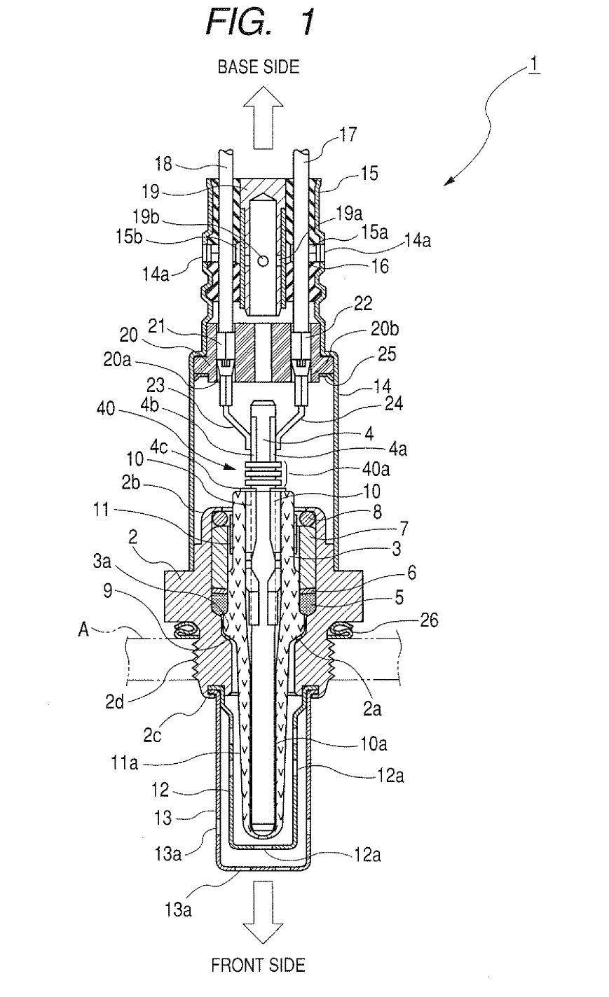

Through following first to fourth embodiments of the present invention, the front side of a gas sensor is shown at the upper side in FIG. 1, and the base side of the gas sensor is shown at the bottom side in FIG. 1.

### First Embodiment

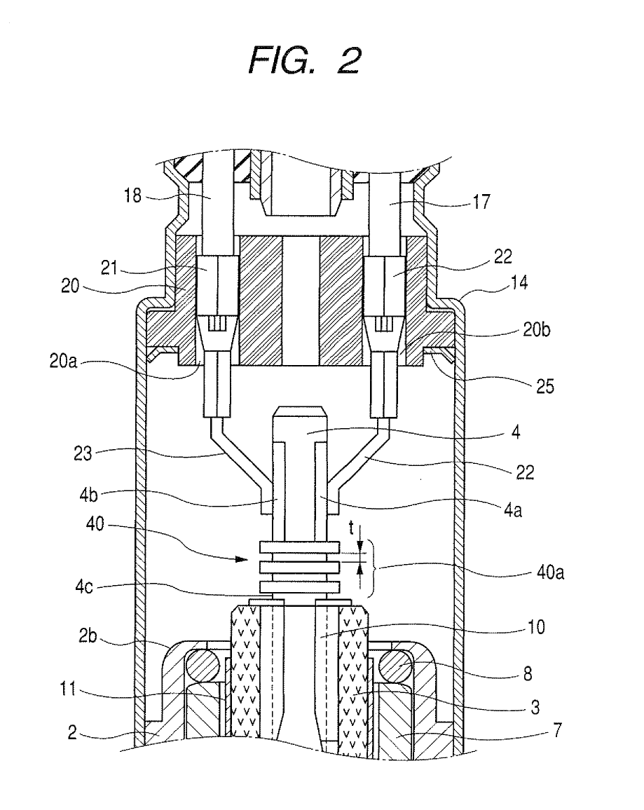

A description will be given of the gas sensor according to the first embodiment of the present invention with reference to FIG. 1 and FIG. 2.

FIG. 1 is a vertical cross section showing the gas sensor according to the first embodiment. FIG. 2 is an enlarged vertical cross section of a part of the gas sensor according to the first embodiment.

The gas sensor 1 according to the present invention acts as an oxygen concentration sensor to be mounted to an exhaust gas purifying system for an internal combustion engine of a motor vehicle.

As shown in FIG. 1, a housing 2 has a cylindrical shape and made of 30 stainless steel with superior heat resistance. A sensor element 3 has a cup shape and is placed in the inside of a hollow part of the housing 2. As shown in FIG. 1, the base end of the sensor element 3 is open and the front side of the sensor element 3 is closed. The sensor element 3 is made of oxygen ion conductivity material such as zirconia (ZrO₂). A longitudinal insulation electrical heater 4 made of ceramic such as alumina is placed in the inside of a hollow part of the sensor element 3. A space formed between the inside surface of the hollow part of the housing 2 and the outer peripheral surface of the sensor element 3 is filled with an insulation powder 5 such as talc.

An insulation powder compact 6 and an insulation sealing member 7 of the shape of a ring are placed in order at the base end of the insulation powder 5. The insulation sealing member 7 is made of ceramic or glass. Further, a shock absorbing member 8 of the shape of a ring made of metal and is placed at the base end of the insulation sealing member 7.

A projection part 3a of the sensor element 3 is fitted to the inside of the hollow part of the housing 2 at a step part 2a of the housing 2 through the shock absorbing member 8 of the shape of a ring.

The base end part 2b of the housing 2 is caulked in order to tightly fix the sensor element 3 in the housing 2.

The calking work makes it possible to completely separate the front end and the base end of the sensor element 3 to each other at the outer peripheral part of the sensor element 3 by the insulation powder 5, the insulation powder shaped body 6 and the insulation sealing member 7 of the shape of a ring. This structure of the sensor element 3 and the housing 2 can prevent any leakage of an exhaust gas from the front end to the base end of the sensor element 3.

A reference electrode metal member 10 is tightly fitted to the inner peripheral surface at the base end of the sensor element 3. The reference electrode metal member 10 is electrically connected to a reference voltage layer 10a formed at the front end of the sensor element 3. A detection electrode metal member 11 is fitted to the outer peripheral surface at the base end of the sensor element 3. The detection electrode metal member 11 is electrically connected to a detection electrode layer 11a formed on the outer peripheral surface at the front end of the sensor element 3. Thus, both the electrode metal members 10 and 11 form a pair of electrodes. A pair of signal wires (not shown) is placed in the vertical direction on the sheet of FIG. 1. An electric power is generated between the electrode layers 10a and 11a.

Through the pair of signal wires, an electric power signal corresponding to the generated electric power as the electromotive force signal is output to the outside device of the gas sensor 1.

An inner cover tube 12 having an exhaust gas inlet hole 12a and an outer cover tube 13 having an exhaust gas inlet hole 13a are caulked at the front end 2c of the housing 2. The inner cover tube 12 and the outer cover tube 13 protect the sensor element 3 from external force or stress to be applied from outside.

Under the condition where the gas sensor 3 is mounted to the exhaust gas purifying system (not shown) for an internal combustion engine, a target exhaust gas to be detected is introduced into the inside of the gas sensor 3 through the exhaust gas inlet hole 12a and the exhaust gas inlet hole 13a.

A cylindrical metal casing 14 is tightly fixed to the base end of the housing 2 by welding.

A pair of sealing members made of insulation elastic member such as rubber is caulked at and tightly fixed to the base end of the casing 14.

A pair of electric wires 17 and 18 is placed along the axial direction of the sealing members 15 and 16. Through the electric wires 17 and 18, an outer electric power is supplied to the insulation electrical heater 4.

Further, a pair of signal lines (not shown) is placed along the axial direction of the sealing members 15 and 16. The signal lines are electrically connected to the electrode metal members 10 and 11.

A plurality of through holes 14a is formed at the outer periphery at the base end of the metal casing 14. The through holes 14a are communicated with side holes 15a and a pair of vent holes 19a and 19b. The side hole 15a is formed in the sealing members 15 and 16. The vent holes 19a and 19b are formed in a filter supporting member 19 which is fitted at the middle part of the sealing members 15 and 16.

An outside gas (air) is introduced into the inside of the metal casing 14 through the through holes 14a, the side hole 15a, and the vent holes 19a and 19b. The outside gas (air) is introduced into a middle hollow part of the sensor element 3, and finally reaches the reference electrode layer 10a.

The two vent holes 19a and 19b are shifted in position to each other within an enlarged hole 15b formed at the inside of the side hole 15a observed from the axial direction of the side hole 15a. This structure enables that at least one of the two vent holes 19a and 19b communicates with the side hole 15a even if an assembling accuracy between the sealing members 15, 16 and the filter supporting member 19 becomes low.

A pair of heater electrodes 4a and 4b (hereinafter, also referred to as the “electrodes 4a and 4b” simply) is formed at the outer peripheral surface at the base end of the insulation electrical heater 4 so that the electrodes 4a and 4b are exposed.

A heating member (not shown) is electrically connected to a node between the electrodes 4a and 4b. This heating member is embedded in the inside of the insulation electrical heater 4. On applying the electric power to the electrodes 4a and 4b, the heating element is heated and the temperature of the heating element rises.

An insulator 20 is tightly fixed to the middle part of the casing 14 by a ring member 25. The insulator 20 is made of insulation material.

A pair of penetration holes 20a and 20b is formed in the insulator 20. A pair of connection metal members 21 and 22 is inserted into the pair of penetration holes 20a and 20b.

As shown in FIG. 1, the electric wires 17 and 18 and lead wires 23 and 24 are caulked together using the connection metal members 21 and 22 so that the electric wires 17 and 18 are electrically connected to the lead wires 23 and 24, respectively, through the connection metal members 21 and 22.

The pair of lead wires 23 and 24 is bent, namely, has a curved shape. One end (at the base end side in FIG. 1) of each of the lead wires 23 and 24 is electrically fixed to the connection metal members 21 and 22. The other end of the lead wires 23 and 24 is connected to the electrodes 4a and 4b by brazing.

The pair of connection metal members 21 and 22 is movable in its position in the insulator 20. That is, the connection metal members 21 and 22 are not fixed to the insulator 20.

One end (at the opposite part to the brazed connection part) of each of the pair of lead wires 23 and 24 electrically connected to the connection metal members 21 and 22 is a free end.

In particular, the gas sensor 1 according to the present invention has an insulation length extension area 40 in the shape of a ring. The insulation length extension area 40 is formed on the outer peripheral surface of the insulation electrical heater 4 between the electrodes 4a and 4b of the insulation electrical heater 4 and the reference electrode metal member 10. This insulation length extension area 40 makes it possible to extend the effective insulation length between the electrodes 4a and 4b and the reference electrode metal member 10 around the outer peripheral surface of the insulation electrical heater 4.

Although the straight-line length between the electrodes 4a and 4b and the reference electrode metal member 10 in the gas sensor of the present invention is substantially equal to that in a conventional gas sensor (approximately, 2.0 mm), the presence (or the formation) of the insulation length extension area 40 can extend the electrical insulation distance without extending the straight-line length between the electrodes 4a and 4b and the reference electrode metal member 10.

The gas sensor 1 having the above configuration according to the first embodiment of the present invention is screwed up and fixed to an exhaust gas pipe A (see FIG. 1) through a gasket 26 by a screw part 2d which is attached to the housing 2.

In the structure of the gas sensor 1 according to the first embodiments the insulation length extension area 40 in the shape of a ring has a flange part 40a. The flange part 40a is composed of a plurality of vertical shaped rectangle flanges placed along the axial direction of the insulation electrical heater 4. Each of the vertical shaped rectangle flanges vertically projects (in a lateral direction on the sheet of FIG. 1 and FIG. 2) from the outer peripheral surface of the insulation electrical heater 4. That is, each vertical shaped rectangle flange is a projecting part.

The vertical shaped rectangle flanges which form the flange part 40a are made of the same insulation material as the electrical heater 4 such as ceramic. Each vertical shaped rectangle flange is a thin. The vertical shaped rectangle flanges which form the ring shaped flange parts 40a are made separated in position from the insulation electrical heater 4. The vertical shaped rectangle flanges are adhered to the outer peripheral surface of the insulation electrical heater 4. It is also possible to form a plurality of vertical shaped rectangle flanges on the outer peripheral surface 4c of the insulation electrical heater 4 by a glass coating process. It is also acceptable to use another insulation material such as glass which forms the flange part 40a composed of the vertical shaped rectangle flanges.

That is, it is possible to select the optimum manufacturing method and material according to necessity in order to form the flange part 40a composed of the vertical shaped rectangle flanges.

The distance or pitch “t” (see FIG. 2) of the adjacent vertical shaped rectangle flanges in the flange part 40a is determined so that insulation characteristics are not deteriorated even if dew condensation is generated here.

In the structure of the conventional gas sensor having a flat shaped outer peripheral surface of the insulation electrical heater, the insulation characteristics are deteriorated when dew condensation is generated.

On the other hand, according to the structure of the gas sensor of the present invention described above, the insulation length extension area 40 of the shape of a ring is formed on the insulation electrical heater 4 in order to extend the electrical insulation length along the surface between the electrode 4a and 4b and the reference electrode metal member 10. This structure of the insulation length extension area 40 can remarkably increase the electrical insulation characteristics between the electrodes 4a and 4b and the reference electrode metal member 10 fitted onto the sensor element 3. Further, this structure can avoid the voltage at the electrodes 4a and 4b from affecting the output voltage at the reference electrode metal member 10 of the sensor element 3. As a result, the above structure of the insulation length extension area 40 according to the first embodiment of the present invention can enhance the reliability of the gas sensor 1.

Furthermore, according to the first embodiment of the present invention, the insulation length extension area 40 is composed of the flange part 40a. The flange part 40a is composed of the vertical shaped rectangle flanges which project from the outer peripheral surface of the insulation electrical heater 4. This structure can increase the electrical surface length, for example, several times of the straight-line length, between the electrodes 4a and 4b and the reference electrode metal member 10. This can increase several times the insulation characteristics between them.

Still further, because the thin shaped vertical shaped rectangle flanges are placed as the flange part 40a on the outer peripheral surface of the insulation electrical heater 4, it is possible to maintain the highly electrical insulation characteristics between the electrodes 4a and 4b and the reference electrode metal member 10 even if there is no adequate margin between them.

### Second Embodiment

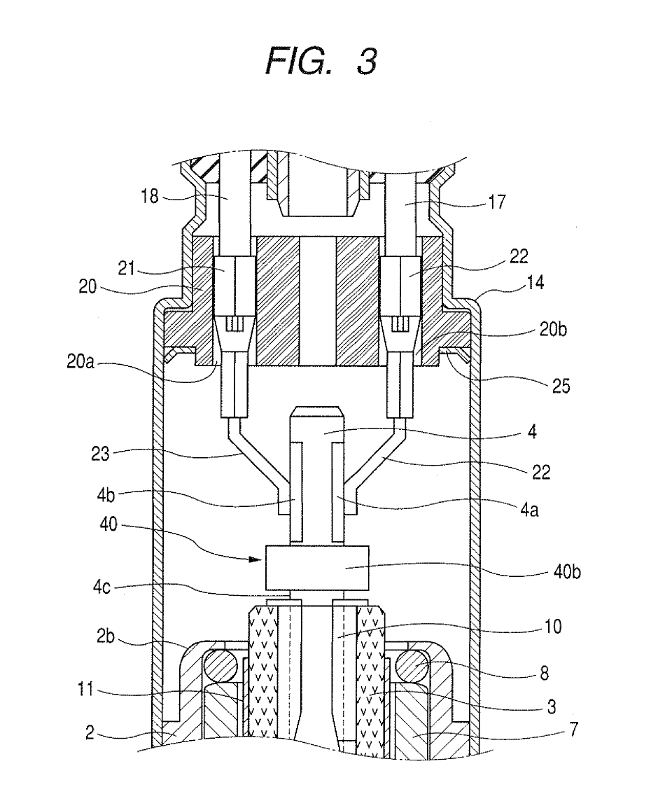

A description will be given of the gas sensor according to the second embodiment of the present invention with reference to FIG. 3.

FIG. 3 is an enlarged vertical cross section of a part of the gas sensor according to the second embodiment. The structural feature of the second embodiment, the insulation length extension area 40 is composed of a rectangle flange part 40b of the shape of a ring (namely, so formed that it surrounds the outer peripheral surface of the insulation member 4). Other components of the gas sensor according to the second embodiment are the same as those in the gas sensor according to the first embodiment shown in FIG. 1 and FIG. 2, the explanation of the same component is omitted here, and the same reference numbers will be used for the same components.

The rectangle flange part 40b of the shape of a ring is formed in one body of the shape of a ring, and vertically projects (in a lateral direction on the sheet of FIG. 3) from the outer peripheral surface 4c of the insulation electrical heater 4.

The rectangle flange part 40b of the shape of a ring is made of ceramic material (namely, so formed that it surrounds the outer peripheral surface of the insulation member 4), like the insulation electrical heater 4. In particular, the rectangle flange part 40b of the shape of a ring and the insulation electrical heater 3 are formed in one body through a firing process using an alumina sheet.

It is also possible to independently form the rectangle flange part 40b of the shape of a ring as an insulation rectangle-shaped ring from the insulation electrical heater 4. In this case, the rectangle flange part 40b of the shape of a ring is fitted and bonded onto the outer peripheral surface 4c of the insulation member 4 by using adhesive.

It is also possible to form the rectangle flange part 40b of the shape of a ring onto the outer peripheral surface 4c of the insulation member 4 by glass coating process. It is also possible to form the rectangle flange part 40b of the shape of a ring using another insulation material such as glass instead of the material of the insulation electrical heater 4. Thus, it is possible to select the optimum manufacturing method and material according to necessity of forming the rectangle flange part 40b of the shape of a ring.

According to the second embodiment of the present invention, because the insulation length extension area 40 is composed of the rectangle flange part 40b of the shape of a ring formed in one body. The rectangle flange part 40b of the shape of a ring projects from the outer peripheral surface 4c of the insulation electrical heater 4, it is possible to extend the effective electrical insulation length along the surface between the electrodes 4a and 4b and the reference electrode metal member 10. This structure can enhance the electrical insulation characteristics between the electrodes 4a and 4b and the reference electrode metal member 10. It is possible to easily form the rectangle flange part 40b of the shape of a ring because the rectangle flange 40b has the shape of a rectangle and a ring.

Still further, because the rectangle flange part 40b of the shape of a ring projects from the outer peripheral surface 4c of the insulation electrical heater 4, it is possible to effectively extend the electrical insulation length or path between the electrodes 4a and 4b and the reference electrode metal member 10 and to obtain the superior electrical insulation characteristics between them.

### Third Embodiment

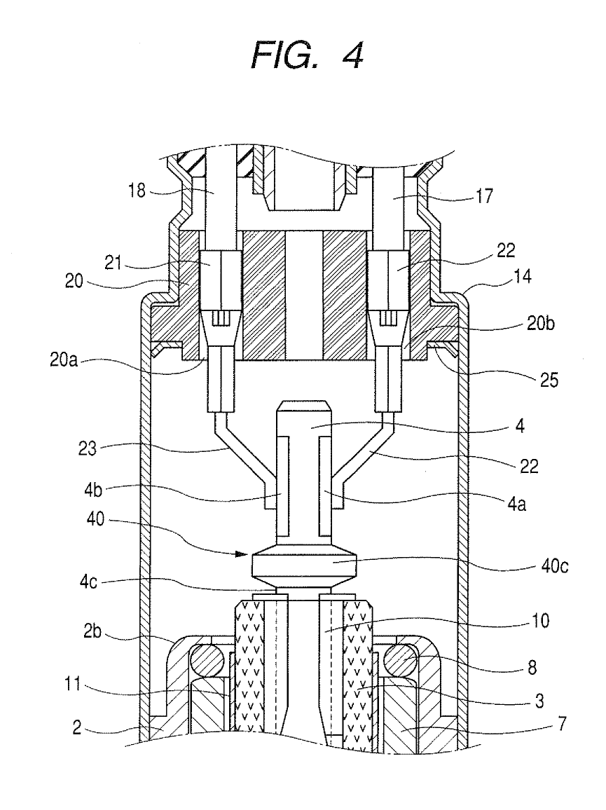

A description will be given of the gas sensor according to the third embodiment of the present invention with reference to FIG. 4.

FIG. 4 is an enlarged vertical cross section of a part of the gas sensor according to the third embodiment. The structural feature of the third embodiment, the insulation length extension area 40 is composed of a taper flange part 40c of the shape of a ring. Other components of the gas sensor according to the third embodiment are the same as those in the gas sensor according to the first embodiment shown in FIG. 1 and FIG. 2, the explanation of the same component is omitted here, and the same reference numbers will be used for the same components.

As shown in FIG. 4, in the structural feature of the insulation length extension area 40, the taper flange part 40c of the shape of a ring has a convergent taper shape at both ends thereof. The taper flange part 40c projects from the outer peripheral surface 4c of the insulation electrical heater 4. The taper flange part 40c is made of the same material of the insulation electrical heater 4, namely, ceramic material. The taper flange part 40c of the shape of a ring and the insulation length extension area 40 are formed in one body by firing process using alumina sheet.

However, it is possible to form an insulation taper ring part independently from the insulation electrical heater 4, and then to bond the insulation taper ring part together onto the outer peripheral surface 4c of the insulation electrical heater 4 using adhesive. Still further, it is also possible to form the taper flange part 40c on the outer peripheral surface 4c of the insulation electrical heater 4 by glass coating process.

The taper flange part 40c is made of ceramic material, like the insulation electrical heater 4. In particular, the taper flange part 40c and the insulation electrical heater 4 are assembled in one body through a firing process using an alumina sheet.

However, it is also possible to independently form the taper flange part 40c as an insulation taper ring part from the insulation electrical heater 4. In this case, the taper flange part 40c is bonded and fixed onto the outer peripheral surface 4c of the insulation member 4 by using adhesive.

It is also possible to form the taper flange part 40c onto the outer peripheral surface 4c of the insulation member 4 through a glass coating process. It is also possible to form the taper flange part 40c using another insulation material such as glass instead of the material of the insulation electrical heater 4. Thus, it is possible to select the optimum manufacturing method and material according to necessity of forming the taper flange part 40c.

According to the third embodiment of the present invention, because the insulation length extension area 40 is composed of the taper flange part 40c which projects from the outer peripheral surface 4c of the insulation electrical heater 4, it is possible to extend the effective electrical-insulation length between the electrodes 4a and 4b and the reference electrode metal member 10. Because having a large contact area between the taper flange part 40c and the outer peripheral surface 4c of the insulation electrical heater 4, this structure makes it possible to strongly bond the taper flange part 40c onto the outer peripheral surface 4c of the insulation electrical heater 4. Further, because the structure has a convergent tapering shape, the taper flange part 40c is free from interference such as resonance vibration with other components such as the sensor element 3 and the base end of the reference electrode metal member 10.

### Fourth Embodiment

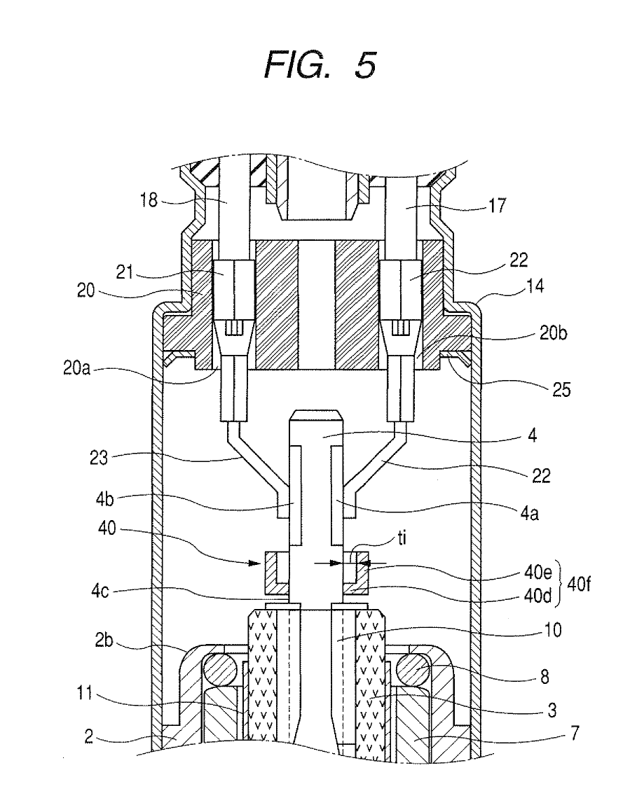

A description will be given of the gas sensor according to the fourth embodiment of the present invention with reference to FIG. 5.

FIG. 5 is an enlarged vertical cross section of a part of the gas sensor according to the fourth embodiment. The structural feature of the fourth embodiment, the insulation length extension area 40 is composed of a bended flange part 40f. The bended flange part 40f is composed of a vertical flange part 40d and a lateral flange part 40e. In particular, as shown in FIG. 5, the vertical flange part 40d projects in vertical direction from the outer peripheral surface 4c of the insulation electrical heater 4. The lateral flange part 40e is extended from the edge of the vertical flange part 40d in the direction along the outer peripheral surface 4c of the insulation electrical heater 4.

The bended flange part 40f is made of the same material of the insulation electrical heater 4, namely, ceramic material. The bended flange part 40f is independently formed as a bended insulation ring part from the insulation electrical heater 4. The bended flange part 40f is tightly bonded onto the outer peripheral surface 4c of the insulation electrical heater 4 by using adhesive.

It is possible to form the bended flange part 40f using another insulation material such as glass instead of the material of the insulation electrical heater 4. Thus, it is possible to select the optimum manufacturing method and material according to the necessity of forming the bended flange part 40f.

As shown in FIG. 5, the lateral flange part 40e in the bended flange part 40f is separated from the outer peripheral surface 4c of the insulation electrical heater 4 by the distance or interval “ti”. This distance “ti” can keep the insulation characteristics even if dew condensation is generated or migration phenomenon occurs between them.

It is also possible to form the lateral flange part 40e of the bended flange part 40f so that the lateral flange part 40e is extended toward the direction of the front end of the gas sensor 1.

According to the fourth embodiment of the present invention, the insulation length extension area 40 has the structure in which the bended flange part 40f is composed of the vertical flange part 40d and the lateral flange part 40e. The vertical flange part 40d projects in a vertical direction from the outer peripheral surface 4c. The lateral flange part 40e is extended from the vertical flange part 40d in the direction along the outer peripheral surface 4c of the insulation electrical heater 4.

It is therefore possible to extend the effective electrical-insulation length between the electrodes 4a and 4b and the reference electrode metal member 10. Further, it is possible to certainly enhance the electrical insulation characteristics between the electrodes 4a, 4b and the reference electrode metal member 10.

### Experimental Results

A description will now be given of experimental results about an output voltage of the gas sensor when the length between an electrode part and a reference electrode metal member including an insulation length extension area is changed.

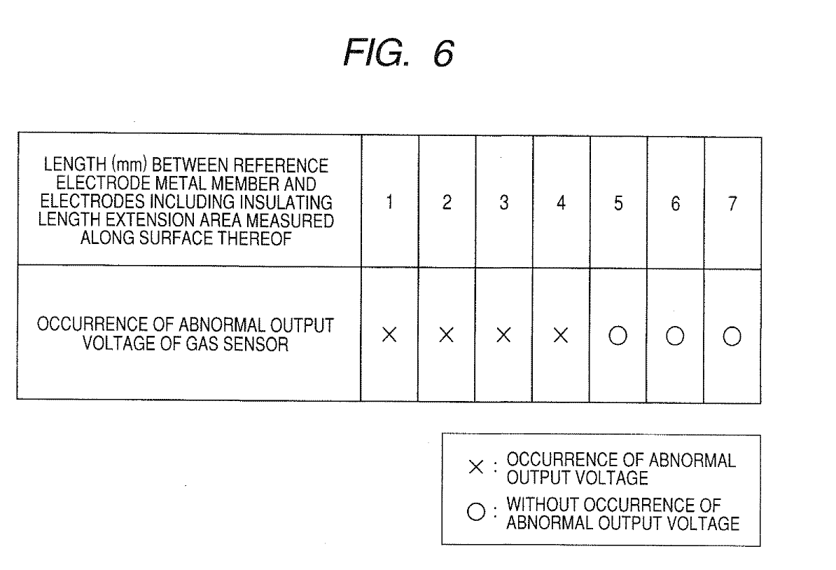

FIG. 6 shows experimental results of an output voltage of the gas sensors having various lengths measured along the surface from the electrodes 4a, 4b including the insulation length extension area 40 to the reference electrode metal member 10. That is, FIG. 6 shows the experimental results regarding the relationship between the output voltage of the gas sensor and the effective length of the insulation length extension area 40.

After considering from the experimental results shown in FIG. 6, it is possible to avoid the occurrence of abnormal output voltage of the gas sensor when the length of the insulation length extension area 40 is not less than 5.0 mm. That is, having the insulation length extension area 40 of not less than 5.0 mm (which is measured along the surface thereof formed between the electrodes 4a, 4b and the reference electrode metal member 10 can enhance the insulation capability without changing or extending the straight-line length between the electrodes 4a, 4b and the reference electrode metal member 10, namely, without increasing the entire size of the gas sensor.

In the gas sensor according to the present invention, the straight-line distance between the electrodes 4a, 4b and the reference electrode metal member 10 is slightly increased, and the insulation length extension area 40 is formed between the electrodes 4a, 4b and the reference electrode metal member 10. Therefore there is a possibility of including a case in which the electrical insulation length between the electrodes 4a, 4b and the reference electrode metal member 10 is not less than 5.0 mm.

It is also preferred that the electrical insulation length between the electrodes 4a, 4b and the reference electrode metal member 10 is within a range of 5.0 mm to 15.0 mm.

The first to fourth embodiments of the present invention show the four types of the insulation length extension area 40. The present invention is not limited by the above embodiments. For example, it is possible to form a concave part in the inside of the outer peripheral surface 4c of the insulation electrical heater 4. That is, it is possible to form various shapes of the insulation length extension area 40 as long as the electrical insulation length measured from the electrodes 4a, 4b including the insulation length extension area 40 and the reference electrode metal member 10 is not less than 5.0 mm.

The longer the electrical insulation length measured along the surface between the electrodes 4a, 4b including the insulation length extension area 40 and the reference electrode metal member 10 becomes, the longer the anti leakage function to due condensation becomes.

Because the gas sensor 1 according to the present invention has a feature in which the voltage at the electrodes 4a and 4b almost does not affect the output voltage of the gas sensor, it is possible to mount the gas sensor as an oxygen concentration sensor to an exhaust gas purifying system. The gas sensor according to the present invention acts as the oxygen concentration sensor with high reliability.

### Other Effects of the Present Invention

In the gas sensor as another aspect of the present invention, the insulation length extension area has a flange part which projects from the outer peripheral surface of the insulation electrical heater. This structure enables the electrical insulation length between the electrodes and the reference electrode metal members to be effectively extended. It is thereby possible to enhance the electrical insulation characteristics between the electrodes and the reference electrode metal members in the gas sensor.

In the gas sensor as another aspect of the present invention, the flange part has a rectangular-shaped flange part formed in one body. The rectangular-shaped flange part vertically projects from the outer peripheral surface of the insulation electrical heater. This structure makes it possible to extend the electrical insulation length between the electrodes and the reference electrode metal members. It is thereby possible to further enhance the electrical insulation characteristics between the electrodes and the reference electrode metal member. Further, because the flange part has a rectangular-shaped flange part which is formed in one body, this structure makes it possible to easily form the insulation length extension area on the outer peripheral surface of the insulation electrical heater.

In the gas sensor as another aspect of the present invention, the flange part is composed of a plurality of flanges formed in an axial direction of the insulation electrical heater. This structure makes it possible to extend several times the electrical insulation length between the electrodes and the reference electrode metal member. Further, because the flange part is composed of a plurality of thin flanges which are formed along an axial direction of the insulation electrical heater, as well as vertically formed on the outer peripheral surface of the insulation electrical heater, it is possible to effectively apply this structure of the insulation length extension area to the gas sensor of a limited space margin.

In the gas sensor as another aspect of the present invention, the flange part has a taper flange part. The taper flange part has a convergent taper shape at both ends thereof. The taper flange part projects from the outer peripheral surface of the insulation electrical heater. This structure also makes it possible to extend the electrical insulation length or path between the electrodes and the reference electrode metal member. Further, this structure makes it possible to avoid occurrence of interference such as resonance vibration with other components in the gas sensor.

In the gas sensor as another aspect of the present invention, the flange part has a bended flange part. The bended flange part is composed of a vertical flange part and a lateral flange part. The vertical flange part projects in vertical direction from the outer peripheral surface of the insulation electrical heater. The lateral flange part is extended from the vertical flange part along the outer peripheral surface of the insulation electrical heater. This structure makes it possible to effectively extend the electrical insulation length between the electrodes and the reference electrode metal member, and thereby possible to more enhance the electric insulation between them. Further, because it is possible to extend the electrical insulation length between them by using the bended the flange part, it is possible to effectively apply this structure of the insulation length extension area having the flange part to the gas sensor having a limited space margin.

In the gas sensor as another aspect of the present invention, the length along the surface measured from the insulation electrode including the insulation length extension area to the reference electrode metal member is at least less than 5.0 mm.

When compared with the structure of a conventional gas sensor, the structure of the gas sensor according to the present invention provides an adequately long electrical insulation length of the insulation length expansion area formed on the outer peripheral surface of the insulation electrical heater between the electrodes and the reference electrode metal member. This structure makes it possible to reduce the influence of the voltage at the electrodes to the output voltage of the sensor element.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A gas sensor comprising:
a sensor element of a cup shape;
an insulation electrical heater configured to heat the sensor element; and
an insulation length extension area formed on an outer peripheral surface of the insulation electrical heater between electrodes of the insulation electrical heater and a reference electrode metal member which is bonded onto the sensor element, wherein the insulation length along the surface of the insulation electrical heater measured from the electrodes to the reference electrode metal member is extended by the insulation length extension area.

2. The gas sensor according to claim 1, wherein the insulation length extension area comprises a flange part which projects from the outer peripheral surface of the insulation electrical heater.

3. The gas sensor according to claim 2, wherein the flange part comprises a rectangle-shaped flange part formed in one body which vertically projects from the outer peripheral surface of the insulation electrical heater.

4. The gas sensor according to claim 2, wherein the flange part comprises a plurality of flanges formed in an axial direction of the insulation electrical heater.

5. The gas sensor according to claim 2, wherein the flange part comprises a taper flange part having a convergent taper shape at both ends thereof, and the taper flange part projects from the outer peripheral surface of the insulation electrical heater.

6. The gas sensor according to claim 2, wherein the flange part comprises a bended flange part which is composed of a vertical flange part and a lateral flange part,
wherein the vertical flange part projects in a vertical direction from the outer peripheral surface of the insulation electrical heater, and the lateral flange part is extended from the vertical flange part along the outer peripheral surface of the insulation electrical heater.

7. The gas sensor according to claim 2, wherein the length along the surface measured from the electrodes including the insulation length extension area to the reference electrode metal member is at least less than 5.0 mm.
